(19) United States
(12) Patent Application Publication
(10) Pub. No.: US 2025/0373321 A1
(43) Pub. Date: Dec. 4, 2025

(54) AIR TRAFFIC COMMUNICATIONS

(71) Applicant: Wisk Aero LLC, Mountain View, CA (US)

(72) Inventors: Craig Scheffler, Estes Park, CO (US); Mark R. Williamson, New Bern, NC (US); Suchitra Palat, Newark, CA (US); Philippe Sabbagh, Palo Alto, CA (US); Geoffrey Alan Long, Montara, CA (US)

(73) Assignee: Wisk Aero LLC, Mountain View, CA (US)

(21) Appl. No.: 19/226,992

(22) Filed: Jun. 3, 2025

Related U.S. Application Data
(60) Provisional application No. 63/655,986, filed on Jun. 4, 2024.

(51) Int. Cl. H04B 7/185; G06F 3/04817; G06F 3/0484; G06F 40/166; G08G 5/26; G10L 15/30; G10L 21/02

(52) U.S. Cl. CPC H04B 7/18502; G06F 3/04817; G06F 3/0484; G06F 40/166; G08G 5/26; G10L 15/30; G10L 21/02

(57) ABSTRACT

Several techniques are provided for improved air traffic control communications that reduce the cognitive burden on a supervisor and improve supervisor comprehension and performance. Broadcasted audio messages (which can include voice communications) can be automatically filtered based on a targeted aircraft, audio transmissions can be transcribed into text for presentation to a supervisor in an understandable visual format, and/or a set of multiple audio messages can be queued and time-shifted to prevent overlap.

### CROSS-REFERENCES TO RELATED APPLICATIONS

This application claims benefit under 35 USC § 119 (e) to U.S. Provisional Patent Application No. 63/655,986 filed Jun. 4, 2024, and entitled “Improved Air Traffic Control Communications,” the disclosure of which is incorporated by reference herein in its entirety for all purposes.

### BACKGROUND OF THE INVENTION

A remote supervisor may remotely supervise multiple aircraft simultaneously. While this improves efficiency, new problems are presented related to a human's ability to process multiple tasks simultaneously. For example, the supervisor may need to monitor and respond to instructions for multiple aircraft, each aircraft receiving instructions communicated by a different air traffic controller over different aviation frequencies. This can include simultaneously monitoring and analyzing multiple audio channels associated with different regions, where each channel includes transmissions for an aircraft under the supervisor's supervision as well as other aircraft that are not under the supervisor's supervision. Also, multiple radio communications for different aircraft monitored by the same supervisor may sometimes arrive at the same time, presenting a difficulty for the supervisor trying to listen to and understand each communication. These complexities present a high cognitive workload for the supervisor or exceed the natural cognitive capabilities of a human, and can lead to errors in supervision and responsive communications.

Embodiments address these, and other problems.

### SUMMARY

Embodiments of the invention provide a method comprising receiving a radio-based audio transmission; generating a live text feed based on the radio-based audio transmission; identifying a predefined text string within the live text feed; and in response to identifying the predefined text string, transmitting a live audio feed of the radio-based audio transmission to the aircraft supervising system.

According to various embodiments, the method can be executed by a processor. The processor can be included as a part of an aircraft supervision system and/or an aircraft including an aircraft communication system.

Embodiments of the invention provide a method comprising receiving a live feed including a plurality of text transcriptions corresponding to a plurality of audio messages, wherein each of the plurality of audio messages is an air traffic control message directed to a corresponding one of a plurality of aircraft, wherein the plurality of aircraft includes a first subset of aircraft associated with an aircraft supervising system; identifying a first subset of the plurality of text transcriptions, wherein each of the first subset of the plurality of text transcriptions correspond to one of the plurality of audio messages that is directed to one of the first subset of aircraft; and displaying, in a first window of a graphical user interface, the plurality of text transcriptions, wherein the first subset of the plurality of text transcriptions are emphasized relative to a remainder of the plurality of text transcriptions.

According to various embodiments, the method can be executed by a processor. The processor can be included as a part of an aircraft supervision system.

Embodiments of the invention provide a method comprising receiving, by an aircraft supervising system, from a first aircraft located in a first geographical region, a first relay of a first audio message being broadcast by first air traffic control system over a first radio channel associated with the first geographical region; acoustically providing, to a supervisor of the aircraft supervising system, the first audio message in real time; during acoustically providing the first audio message, receiving, by the aircraft supervising system, from a second aircraft located in a second geographical region, a second relay of a second audio message being broadcast by second air traffic control system over a second radio channel associated with the second geographical region; and after completing the acoustically providing the first audio message, acoustically providing, to the supervisor, the second audio message.

Further details regarding embodiments of the invention can be found in the Detailed Description and the Figures.

### BRIEF DESCRIPTION OF THE DRAWINGS

Various embodiments of the invention are disclosed in the following detailed description and the accompanying drawings. In the appended figures, similar components or features may have the same reference label.

FIG. 1 shows an example voice communications system, according to one or more embodiments.

FIG. 2 illustrates a block diagram of an example audio communication network, according to one or more embodiments.

FIG. 3 shows a flowchart of a method for filtering audio transmissions, according to one or more embodiments.

FIG. 4A illustrates a first example of a graphical user interface for a supervisor, according to one or more embodiments.

FIG. 4B illustrates a second example of a graphical user interface for a supervisor, according to one or more embodiments.

FIG. 5 illustrates a representation of multiple audio messages that overlap in time, according to one or more embodiments.

FIG. 6 illustrates a representation of time-shifted audio messages, according to one or more embodiments.

FIG. 7 shows a flowchart of a method for providing time-shifting audio messages, according to one or more embodiments.

FIG. 8 provides a schematic illustration of a computer system, according to one or more embodiments.

### DETAILED DESCRIPTION OF THE INVENTION

Embodiments provide several techniques for improved air traffic control communications that reduce the cognitive burden on a supervisor and improve supervisor comprehension and performance. In some embodiments, broadcasted audio messages (which can include voice communications) can be automatically filtered based on a targeted aircraft, audio transmissions can be transcribed into text for presentation to a supervisor in an understandable visual format, and/or a set of multiple audio messages can be queued and time-shifted to prevent overlap.

### Voice Communications System

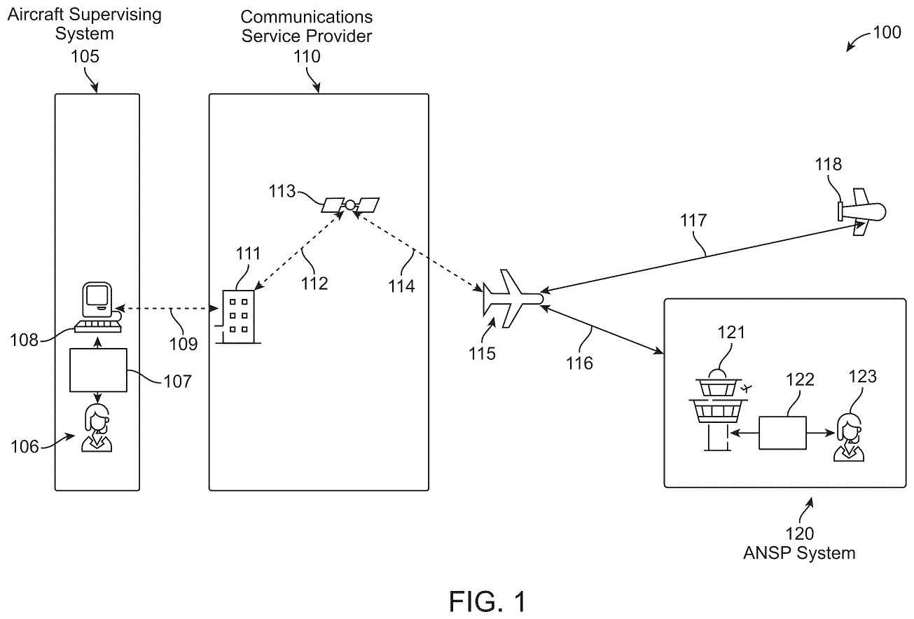

FIG. 1 is an illustration of an example voice communications system 100 for voice communications between a remote supervisor (RS) and an air traffic controller (ATC), according to one or more embodiments. The voice communications system 100 may include one or more aircraft supervising systems 105, one or more communications service providers (CSPs) 110, one or more aircraft (e.g., aircraft 115 and aircraft 118), and/or one or more air navigation service provider (ANSP) systems 120.

The aircraft supervising system 105 may include an RS 106 and a ground control station (GCS) 108. According to embodiments, the GCS 108 can include a remote supervisor workstation with components such as a computer system with various inputs and outputs, such as a visual display, audio speakers, a human voice interface 107 such as a microphone, a keyboard, etc. The GCS 108 may be communicatively coupled with the communications service provider 110. The RS 106 may be a human operating the GCS 108 or an automated system. In some embodiments, the RS 106 may supervise and/or monitor an aircraft (e.g., 115 and/or 118) including the flight plan and other flight parameters for the aircraft, identify and communicate potential hazards to the aircraft, etc. The aircraft may be autonomous or semi-autonomous, and/or the aircraft may have limited onboard crew or no onboard crew. In some embodiments, the RS 106 may include a remote pilot for an unmanned aerial vehicle (UAV).

The CSP 110 may include communication infrastructure configured to communicate with one or more aircraft (e.g., 115 and 118). The CSP 110 may be used to communicatively link the GCS 108 and the aircraft 115. The CSP 110 may include terrestrial and/or satellite components. Terrestrial communications infrastructure 111 can include gateway and/or information technology (IT) systems, which can include computer systems. The CSP 110 may include air-ground (A< >G) communications infrastructure 113, such as a satellite, tower, and/or high frequency (HF) radio.

The ANSP system 120 may include any suitable components, computer systems, and/or operators for providing air traffic control services. For example, the ANSP system 120 can include an ATC system 121 which can include radio infrastructure, computer systems, and/or facilities such as tower configured to accommodate personnel. The ANSP system 120 can also include one or more ATC controllers 123 (e.g., human operators or automated systems) that interact with the ATC system 121 to determine and provide air traffic control instructions to one or more aircraft.

The voice communications system 100 may be configured to relay voice communications such that the RS 106 can communicate with the ATC controller 123. For example, a voice message (e.g., speech) of the remote supervisor 106 may be received by the human voice interface 107 of the GCS 108. The GCS 108 can then convert the voice message from an analog format to a digital format via encoding. The digitally encoded voice message can then be sent to the aircraft 115 via one or more communications links. For example, the GCS 108 can transmit the digitally encoded voice message to the terrestrial communications infrastructure 111 via a ground-to-ground (G< >G) voice link 109.

The terrestrial communications infrastructure 111 can then transmit the digitally encoded voice message to the A< >G communications infrastructure 113 via an A< >G intra-network voice link 112. The A< >G communications infrastructure 113 can then transmit the digitally encoded voice message to the aircraft 115 via an A< >G aircraft voice link 114.

At the aircraft 115, the digitally encoded voice message may be converted to an analog format (e.g., via an onboard computer system). The analog voice message may then be transmitted by the aircraft's radio (e.g., a very high frequency (VHF) radio). One or more ground receivers of the ATC system 121 may receive the radio signal with the analog voice message. Communicative coupling between the aircraft 115 and the ATC system 121 via radio transmissions can be referred to as an A< >G ATC analog voice link 116.

The ATC system 121 may use a computer system and/or human voice interface 122 to process the radio signal to extract the analog voice message and provide the analog voice message to the ATC controller 123 (e.g., via a listening device such as a headset or other audio speakers).

According to embodiments, the voice communications system 100 may also be configured to relay voice communications in the opposite direction, such that a voice message from the ATC controller 123 can be provided to the RS 106. The process of providing voice communications from the ATC controller 123 to the RS 106 may involve processing and transmitting the voice message in the opposite direction in comparison with the message flow described above.

Disclosed embodiments may be applicable to satellite communications links to aircraft as well as other types of communication links. Embodiments according to the present disclosure may be applicable to any suitable type of communications method used to transport ATC voice messages via the aircraft relay method where cost efficiency and spectrum efficiency are desired. Communications links between an RS's GCS 108 and aircraft 115 may be physically implemented in a number of different ways, such as a point-to-point RF link, a CSP 110 that has a network of transmitters and receivers (e.g., a satellite provider), and/or a terrestrial network such as a cellular mobile network operator. For example, the A< >G intra-network voice link 112 may correspond to a high frequency (HF) radio transporting voice in any propagation path. In that example, the A< >G link 114 between the HF transceiver of the A< >G communications infrastructure 113 and the aircraft 115 may utilize the same HF frequency for all aircraft operating in the same VHF frequency.

With consolidated voice links, for all aircraft 115 of a particular aircraft supervising system 105 flying in the same RF service volume, all RS 106 voice transmissions may be transported by only one active air-to-ground voice link 114 to only one aircraft 115. All ATC controller 123 voice transmissions may be transported by only one active air-to-ground voice link 116 to the one aircraft 115. Additionally, all proximate air-to-air (A< >A) aircraft pilot voice communications 117 from other aircraft 118 (that, for example, may not be operated by the aircraft supervising system 105 and may not be remotely operated) may be transported by the one active air-to-ground voice link to the one aircraft 115.

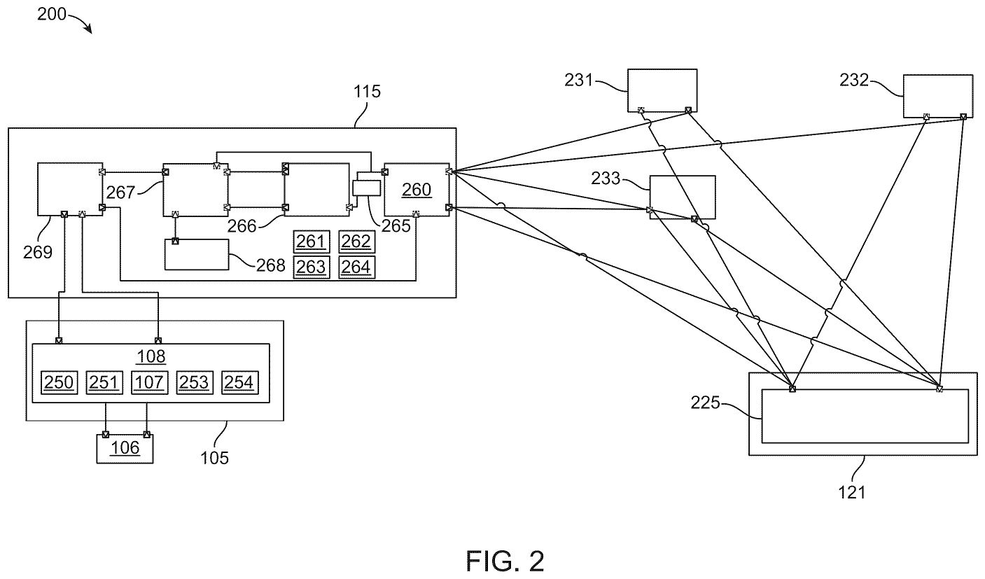

Embodiments described below with respect to FIGS. 2-6 can be utilized in conjunction with the voice communications system 100 of FIG. 1.

### Filter Channel for Targeted Audio Messages

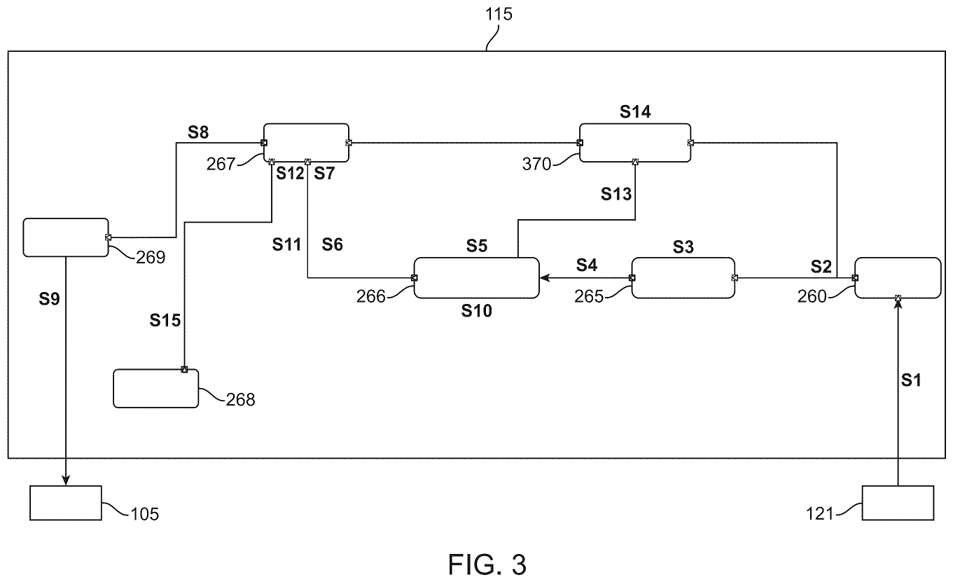

According to embodiments, broadcasted audio transmissions can be automatically filtered based on aircraft identifier. An aircraft identifier can include callsign, name, alphanumeric code, or any other suitable identifier. When a predefined aircraft identifier is identified in an audio transmission (or within a text transcription of the audio transmission), the audio transmission can be provided to a supervisor monitoring the aircraft. Audio filtering techniques can be described with respect to FIG. 2 and FIG. 3.

FIG. 2 illustrates an audio communication network 200. The audio communication network 200 can include an air traffic control system 121, an aircraft supervising system 105, and/or any suitable number of aircraft such as aircraft 115, 231, 232, and/or 233, each of which may be in operative communication with one another. According to embodiments, some or all of the audio communication network 200 of FIG. 2 may be similar to the voice communications system 100 described above with respect to FIG. 1. For example, the air traffic control system 121 of FIG. 2 may be similar to the air traffic control system 121 of FIG. 1, the aircraft supervising system 105 of FIG. 2 may be similar to the aircraft supervising system 105 of FIG. 1, and/or the aircraft 115 of FIG. 2 may be similar to the aircraft 115 of FIG. 1.

The air traffic control system 121 (also referred to as a transmission station) can include communication equipment 225 such as one or more radio transceivers, one or more computers, one or more human operators (e.g., an air traffic controller), and/or any other suitable equipment.

The air traffic control system 121 may broadcast radio transmissions for communicating with one or more aircraft in the region. For example, the air traffic control system 121 can provide spoken voice audio instructions for coordinating aircraft approaching and/or exiting an airport area. Audio instructions can be transmitted through a predefined channel, such as a certain radio frequency or frequency band. Accordingly, multiple instructions for different aircraft may be transmitted over the same radio channel. Additionally, responsive communications can be transmitted via and received through the same radio channel.

Each aircraft 115, 231, 232, and 233 may be in flight within a predefined region or predefined distance from the air traffic control system 121. For example, each aircraft 115, 231, 232, and 233 may be within radio communication range of the air traffic control system 121 and/or a predefined region associated with the air traffic control system 121.

Each aircraft 115, 231, 232, and 233 can include various onboard equipment such as communication equipment, one or more computers (e.g., flight control system computers), and/or or any other suitable equipment. As an example, components are illustrated for the aircraft 115. As shown, the aircraft 115 can include communication equipment 260 such as radio equipment (e.g., one or more radio transceivers such as a VHF radio). Additionally, the aircraft 115 can include a visual interface 261 (e.g., display screen), an audio interface 262 (e.g., speakers and/or microphone), one or more computer processors 263, a memory 264, any other suitable input devices or output devices, and/or any other suitable equipment.

According to embodiments, the aircraft 115 may include one or more communication processing modules. As shown, the aircraft 115 can comprise a speech-to-text module 265 (e.g., an automatic speech recognition system), a text analysis module 266, a filtering module 267, a relay module 269, an external squelch control override module 268, and/or any other suitable modules and components. Some or all of the modules and hardware of the communication system can be considered a part of a communication system and/or control system of the aircraft 115. As discussed in more detail below with respect to FIG. 3, these modules can be configured to filter (e.g., squelch) the radio transmissions such that only targeted audio messages are relayed to the aircraft supervising system 105 and/or text transcriptions can be provided to the aircraft supervising system 105.

The aircraft supervising system 105 (also referred to as an operator system) can, in some embodiments, include one or more ground control stations 108 for remote aircraft supervising and/or piloting. The ground control station 108 can include various hardware equipment, such as communication equipment 250 (e.g., one or more radio transceivers), a visual interface 251 (e.g., display screen), a human voice interface 107 (e.g., also referred to as an audio interface), one or more computer processors 253, memory 254, any other suitable input devices or output devices, and/or any other suitable equipment for remotely supervising and/or operating one or more aircraft. The aircraft supervising system 105 can be located on the ground, or otherwise physically separate from the aircraft 115, 231, 232, and 233.

One or more supervisors 106 (e.g., human operators) may use or otherwise interact with the aircraft supervising system 105. Each supervisor 106 may operate a corresponding ground control station 108 through which the supervisor 106 can supervise one or more aircraft simultaneously. For example, the supervisor 106 may supervise one, two, three or more aircraft at the same time.

For simplicity, a communications service provider is not illustrated in FIG. 2 or FIG. 3. However, embodiments allow a communications service provider to facilitate communications between the aircraft supervising system 105 and the aircraft 115 as discussed above with respect to FIG. 1.

A method for filtering audio transmissions can be described with respect to FIG. 3.

At step S1, an aircraft 115 can receive a radio-based audio transmission (e.g., via communication equipment 260 of an aircraft communication system). The audio transmission (also referred to as an audio stream or a live feed) can include iterative, simultaneous, and/or continuous audio messages broadcasted over a predefined radio channel by the air traffic control system 121, one or more of aircraft 231, 232, 233, and/or any other entities with radio equipment. Some of the audio messages within the audio transmission may be directed to the aircraft 115. For example, some of the audio messages may be air traffic control messages from the air traffic control system 121 directed to the aircraft 115. The audio transmission may include audio messages intended for other aircraft or other systems. According to embodiments, the aircraft 115 can receive the radio-based audio transmission prior to relaying the radio-based audio transmission to an aircraft supervising system 105.

At step S2, the communication equipment 260 can provide (e.g., simultaneously or sequentially) the audio transmission to one or more other components of the aircraft's communication system. For example, the audio transmission can be provided to a speech-to-text module 265, a filtering module 267, and/or an emphasizer module 370, simultaneously, sequentially, or in an overlapping order.

At step S3, the aircraft 115 (e.g., via the speech-to-text module 265) can generate text based on the radio-based audio transmission (e.g., the spoken words contained within the audio transmission). The speech-to-text module 265 may continuously transcribe to generate a live text feed of the radio-based audio transmission from the selected radio channel as it arrives at the aircraft 115.

At step S4, the speech-to-text module 265 can provide the generated text to a text analysis module 266 of the aircraft 115.

At step S5, the aircraft 115 (e.g., via the text analysis module 266) can analyze the text to identify any instances of a predefined text string (or one of a plurality of predefined strings). As examples, the predefined text string can be a specific word, code, or phrase. A predefined text string may be an aircraft identifier (e.g., as stored in an onboard database) associated with an aircraft 115, and/or that is spoken in the audio transmission to announce that an immediately following message is directed to the aircraft 115. Accordingly, by identifying the predefined text string, the aircraft 115 can determine that the following audio message is directed to the aircraft 115. The aircraft 115 may continuously analyze an incoming text stream in real time.

At step S6, the text analysis module 266 can transmit to the filtering module 267 an indication that the predefined text string has been detected.

At step S7, the aircraft 115 (e.g., via the filtering module 267) can determine to activate forwarding of the audio transmission to the aircraft supervising system 105 in response to the detection of the predefined text string. For example, the aircraft 115 may be configured to, by default, mute (also referred to as “squelch”) the audio transmissions or otherwise not forward the audio transmissions to the aircraft supervising system 105. However, upon detecting the predefined text string within the text stream, the aircraft 115 can provide a live audio feed of the received audio transmissions to the aircraft supervising system 105. Accordingly, the predefined text string can effectively function as a control signal (which can be referred to as a squelch control signal) for activating transmission of the audio transmission to the aircraft supervising system 105.

At step S8, the filtering module 267 can transmit a live audio feed of the audio transmission to the relay module 269.

At step S9, the aircraft 115 (e.g., via the relay module 269) can transmit the live audio feed of the audio transmission to the aircraft supervising system 105. The relay module 269 can include or utilize an aircraft-to-ground communications system such as an aircraft C2 radio. The aircraft-to-ground communications system may utilize different equipment and/or channels than the communication equipment 260 used for communications with the air traffic control system 121.

Steps S3-S7 can be performed in real time with effectively no delay such that the forwarding of the audio transmission at step S9 can be activated immediately, thereby ensuring that the relevant audio message is passed to the aircraft supervising system 105 within the forwarded live feed of the audio transmission.

At step S10, the aircraft 115 (e.g., via the text analysis module 266) can identify a second instance of the predefined text string (or one of a plurality of predefined strings). For example, the predefined text string may be spoken a second time in the audio transmission to announce that the message is directed to the aircraft 115 has ended. Accordingly, by identifying the predefined text string, the aircraft 115 can determine that the audio message directed to the aircraft 115 has been completed.

At step S11, the text analysis module 266 can transmit to the filtering module 267 an indication that a second instance of the predefined text string has been detected.

At step S12, the aircraft 115 (e.g., via the filtering module 267) can terminate forwarding of the audio transmission to the aircraft supervising system 105. For example, the aircraft can determine to deactivate the audio transmission in response to the second detection of the predefined text string. The aircraft 115 can return to a mute condition where the audio transmission is not forwarded to the aircraft supervising system 105. Accordingly, the second instance of the predefined text string can effectively function as a control signal for deactivating transmission of the audio transmission (also referred to as terminating, muting, or closing the squelch) to the aircraft supervising system 105.

According to embodiments, the aircraft 115 (e.g., the filtering module 214) can determine to deactivate the audio transmission at any suitable time. For example, the aircraft 115 can deactivate the audio transmission at the end of a targeted transmission as indicated by a second detection of the predefined text string as discussed above, or at the end of a targeted transmission as indicated by a predefined period of silence (e.g., no spoken words on the radio channel for 1 second, 2 seconds, 5 seconds, 10 seconds, or any other suitable amount of time). In additional examples, the aircraft 115 can deactivate the audio transmission in response to detecting a different aircraft identifier (e.g., as indicating the beginning of a message for a different aircraft) or other predefined text string, after a predefined amount of time has elapsed since the predefined text string was detected at step S5 (e.g., 10 seconds, 20 seconds, 50 seconds, 2 minutes, or any other suitable amount of time), in response to an external trigger source such as human command, etc.

With broadcast radio communications, it may be possible to receive simultaneous and conflicting audio messages from different sources on the same radio channel. This can cause the intended audio message to become obscured or otherwise difficult to understand. In some embodiments, to compensate for such a conflict, the aircraft 115 can emphasize the audio message intended for the aircraft 115. For example, the aircraft 115 can isolate the audio message directed to the aircraft 115 and lower or mute other simultaneous messages. In another example, the aircraft 115 can amplify the audio message directed the aircraft 115 so that it is louder than other noise or otherwise stands out within a cluttered audio transmission.

For example, at step S13, the text analysis module 266 can transmit to an emphasizer module 370 an indication that the predefined text string has been detected. At step S14, the aircraft 115 (e.g., via the emphasizer module 370) can emphasize the audio message in response to the detection of the predefined text string. For example, the aircraft 115 can identify a voice (e.g., speech pattern, voice pitch, signal strength, or other audio quality) associated with the predefined text string, and then modify the audio transmission such that the identified voice is emphasized (e.g., as it continues speaking the audio message). The emphasizer module 370 can then provide the modified audio transmission with emphasized audio message to the filtering module 267. While these steps are labeled as S13 and S14 in FIG. 3, they can be performed at any suitable time. For example, step S13 can be performed at the same or a similar time as step S6, and step S14 can be performed at the same or similar time as step S7. Step S14 can be performed at a time that allows the forwarded audio transmission at steps S8 and S9 to be the modified audio transmission with the emphasized audio message. According to embodiments, all of the method steps can occur instantly in real time from the supervisor's perspective such that the audio message is relayed, filtered, and/or emphasized without delay.

As a result of the method, the aircraft supervising system 105 can receive audio transmissions from the aircraft 115 and/or the radio channel when the audio transmission includes information directed to the aircraft 115 (e.g., as identified by the aircraft identifier in the text stream), and any other audio transmissions on that radio channel not directed to the aircraft 115 can be filtered, excluded, and/or diminished.

Techniques that filter channel for targeted audio messages reduce the cognitive workload for a supervisor at the aircraft supervising system 105, as the supervisor may not need to attentively listen to all audio traffic on the radio channel for possible audio message directed to the supervisor's aircraft. Instead, any audio messages provided to the supervisor can be relevant for the supervisor, and the radio channel can otherwise remain silent from the supervisor's perspective.

Further, in some embodiments, a supervisor may supervise multiple aircraft spread around two or more geographical regions. It may be impractically burdensome for a single supervisor to attempt to listen to all audio traffic across multiple radio channels simultaneously, scanning for possible messages directed to two or more aircraft associated with the supervisor. Instead, each aircraft can filter their respective radio channel traffic and only pass through to the supervisor relevant messages for that aircraft.

Embodiments also advantageously reduce the processing costs associated with forwarding a radio channel's audio traffic from the aircraft 115 to the aircraft supervising system 105 by reducing the amount of audio information being forwarded.

According to embodiments, the aircraft 115 may provide the audio transmission to the aircraft supervising system 105 in response to other triggers, such as detecting other aircraft identifiers for other aircraft that may be of concern, an onboard human command, an instruction received from the aircraft supervising system 105, or any other suitable trigger. For example, at step S15, an external squelch control override module 268 can cause the filtering module 267 to activate forwarding of the audio transmission to the aircraft supervising system 105. The external squelch control override module 268 may override muting of the audio transmission in response from an instruction received from the aircraft supervising system 105. As a result, the audio transmission can be provided to the aircraft supervising system 105 at times when the predefined text string has not been detected and/or there are no current audio messages directed to the aircraft 115. Step S15 can be performed at any suitable time before, during, and/or after other steps.

Upon receipt of an audio message directed to the aircraft 115, the supervisor can analyze the message, determine a response, and the aircraft supervising system 105 can transmit the response to the aircraft 115. The response may include a control instruction for the aircraft 115 (e.g., turn right by 90 degrees) and/or a voice response for the air traffic control system 121 (e.g., repeating an instruction, confirming an instruction will be followed, indicating that an instruction will not be followed, providing information about a current aircraft heading). In some embodiments, the aircraft 115 can broadcast the voice response on the radio channel (e.g., via onboard VHF radio) for detection by the air traffic control system 121. In some embodiments, the supervisor may enter the response as text, and the aircraft supervising system 105 may convert the text to speech for transmission to the air traffic control system 121.

In alternative embodiments, instead of relaying a voice response to the air traffic control system 121 through the aircraft 115, the aircraft supervising system 105 can transmit the response to the air traffic control system 121 through one or more VHF radio towers (e.g., which may be separate from and/or supplemental to FAA or other ANSP (Air Navigation Service Provider) infrastructure). In another alternative embodiment, the aircraft supervising system 105 can transmit a voice response to the air traffic control system 121 directly through a “ground-ground” Voice Over IP connection supplied by a communications service provider.

The audio filtering process is described as be performed by communication systems of the aircraft 115. In some alternative embodiments, the audio filtering process may instead be performed by the aircraft supervising system 105. For example, all audio transmissions (e.g., a complete, unfiltered live audio feed) on one or more radio channels can be forwarded from one or more aircraft to the aircraft supervising system 105. Some or all of the modules discussed above can be included in the aircraft supervising system 105. The aircraft supervising system 105 can thereby filter the audio transmissions (e.g., based on one or more targeted aircraft as discussed above), and then provide the filtered audio signal to the supervisor.

User Interface with Text Transcription

According to embodiments, an audio transmission and/or audio message within an audio transmission can be transcribed into text for presentation to a supervisor. A visual stream or queue of text transcriptions can be presented in order of time received to the supervisor via a user interface. The stream can be a live stream (also referred to as a “live feed”) that is updated in real-time with new text transcriptions upon receipt of new audio messages.

A text transcription can provide a backup reference source to confirm information heard via an audio message and/or a secondary source that can be reviewed in the case of a missed audio messages, thereby reducing the cognitive workload of the supervisor, improving comprehension, and reducing potential errors. Audio transcription techniques can be described with respect to FIG. 3.

As discussed above with respect to step S3, the aircraft 115 (e.g., via the speech-to-text module 265) can convert an audio transmission's spoken words into text. According to embodiments, some or all of the text transcription can be forwarded to the aircraft supervising system 105. As an example, step S6 can further include providing the text transcription (e.g., a live feed of transcribed words as they are generated) to the filtering module 267. Step S7 can further include determining to activate forwarding of the text transcription to the aircraft supervising system 105 (e.g., in response to the detection of the predefined text string). Step S8 can further include transmitting a live feed of the text transcription to the relay module 267, and step S9 can further include transmitting the live feed of the text transcription to the aircraft supervising system 105.

In some embodiments, instead of receiving the text from the aircraft 115, the aircraft supervising system 105 can itself generate the text based on audio transmissions received from the aircraft 115.

In some embodiments, the aircraft 115 may provide to the aircraft supervising system 105 transcribed text that corresponds to an identified audio message (e.g., based on a predefined text string). The text transcription can be provided to the aircraft supervising system 105 in addition to an audio transmission. For example, in some embodiments, the aircraft 115 filters audio transmissions (as discussed above) for relevant audio messages, and the aircraft 115 provides the filtered audio messages with corresponding filtered text transcriptions to the aircraft supervising system 105. In other embodiments, the aircraft 115 may provide to the aircraft supervising system 105 a complete text transcription of all audio transmissions of a radio channel.

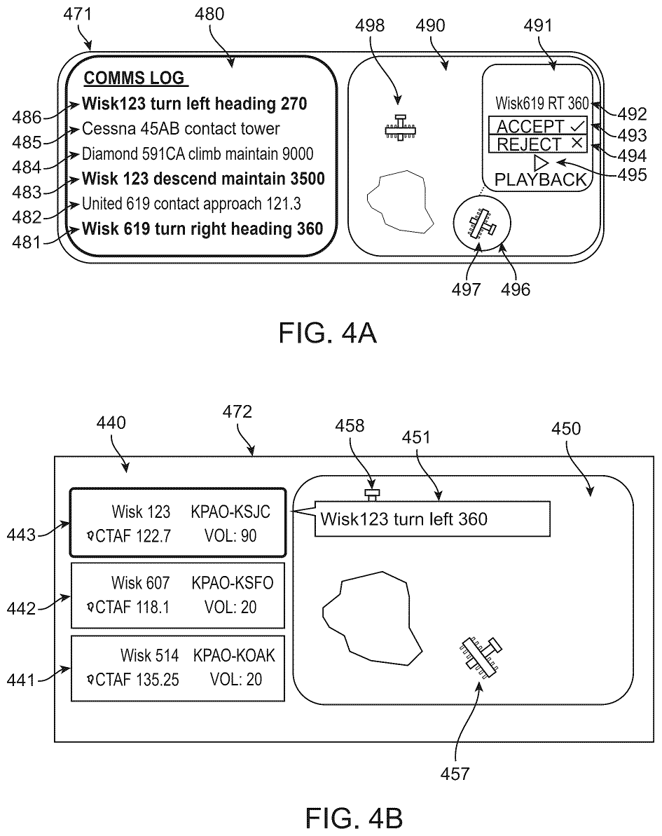

The aircraft supervising system 105 can generate a display based on information received from the aircraft 115. For example, a ground control station of the aircraft supervising system 105 can provide a graphical user interface for a remote supervisor of the aircraft supervising system 105. Examples of graphical user interfaces that may provided by the ground control station are shown in FIG. 4A and FIG. 4B, according to embodiments.

FIG. 4A illustrates an example graphical user interface 471 that can include a text transcription portion 480 and an optional a map portion 490.

The text transcription portion 480 (also referred to as a first window) can include a series or list of transcribed messages 481-486. Each of the transcribed messages 481-486 may correspond to a specific aircraft. For example, the transcribed messages 481-486 can be displayed as separate entries (e.g., separate lines or chunks of text) in a vertical stack. In some embodiments, the text transcription portion 480 can provide a scrolling visual live stream (also referred to as a “live feed”) of text transcriptions can be displayed. New text may appear at the top or the bottom of the scrolling display window. For example, in response to receiving a subsequent text transcription, the graphical user interface can be automatically updated to display the subsequent text transcription as a new entry in the vertical stack and by vertically scrolling the vertical stack to include the subsequent text transcription. In the example of FIG. 4A, newer messages are shown at the bottom of the text transcription portion 480. Text can be added on a word-by-word, phrase-by-phrase, or message-by-message basis.

Referring back to FIG. 3, the aircraft supervising system 195 may receive from the aircraft 115 all transcribed text for one or more radio channels. For example, whether or not the audio transmission is partially filtered, text transcriptions of all audio messages (e.g., a continuous stream) on the radio channel may be passed to the aircraft supervising system 105. The aircraft supervising system 105 can then generate a graphical user interface that allows the supervisor to review text transcriptions of other activity in a certain area, without necessarily having to listen to all audio messages on the radio channel.

In some embodiments, the graphical user interface 471 of FIG. 4A may include emphasized text transcriptions for audio messages that are directed to aircraft associated with the supervisor. For example, transcribed messages 481, 483, and 486 may be emphasized due to being directed to an aircraft associated with the aircraft supervising system 105, ground control station, and/or supervisor. Emphasizing can include providing a visual cue (e.g., highlight, bold, enlarged text, italics, underline, differentiated font, differentiated color, etc.). As a result, if a complete transcription of all audio activity on a radio channel is provided to the supervisor, text corresponding to specific audio messages that are targeted at one of the supervisor's aircraft can be emphasized within a greater list of messages.

Further, in some embodiments, when audio transmissions and/or corresponding text transcriptions of non-targeted messages (e.g., messages for aircraft that are not under the supervisor's supervision) are presented to the supervisor, those messages may be presented in a non-emphasized or de-emphasized manner. For example, via attenuated audio volume, smaller text, dimmer text, otherwise diminished text, or non-emphasized text. As shown in FIG. 4A, transcribed messages 482, 484, and 485 may be presented as non-emphasized or de-emphasized based on being associated with aircraft that are not under the supervision of the supervisor.

In some embodiments, the graphical user interface 471 may indicate when a certain transcribed message has been responded to, acted upon, or otherwise acknowledged. For example, transcribed message 486 may have already been acted upon, and this may be indicated in the graphical user interface by a second type of emphasis (e.g., different color, removal of a highlight, reduction in size of text, etc.) that is distinct from the emphasis described above, but that may also remain distinct from messages for aircraft not under the supervision of the supervisor.

In some embodiments, the aircraft supervising system can produce an alert signal or emphasis when a transcribed message (and/or an audio message) related to the supervisor's aircraft arrives (e.g., as identified based on a predefined aircraft identifier). The alert can include one or more of an audio alert such as a chime, ping, or emphasized audio (e.g., increased volume), and/or a visual alert on the graphical user interface 471 such as a flash, brightening the screen, and/or emphasized or extra-emphasized text (e.g., a temporary increase in size, boldness, color, etc.). This can advantageously differentiate a targeted message from other messages and capture the supervisor's attention, thereby helping the supervisor focus on that specific message on that specific channel and temporarily disregard other chatter and/or text from other radio channels. Additionally, emphasized and differentiated messages (e.g., via emphasized text) can be more easily identified when scrolling backward through past messages (e.g., to check for missed messages or review a previous message).

As mentioned above, a single supervisor may be supervising multiple aircraft and their corresponding radio channels simultaneously. As a result, different audio transmissions on different radio channels that are simultaneously broadcast or overlapping in time may arrive at the aircraft supervising system at the same time or overlapping times. According to embodiments, text transcriptions from different radio channels can be combined into a single visual live stream on the graphical user interface 471. For example, transcribed messages 482, 483, and 486 may have been transmitted over a first radio channel corresponding to a first region, while transcribed messages 481, 484, and 485 may have been transmitted over a second radio channel corresponding to a second region.

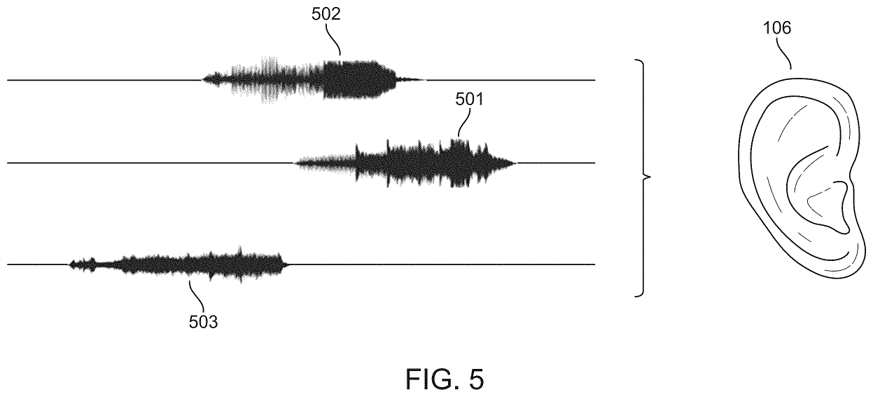

Further, simultaneous or overlapping messages can be separated and presented iteratively. For example, if the aircraft supervising system is in the process of displaying (e.g., on a word-by-word basis) a first text transcribed message from a first radio channel (e.g., received from a first aircraft in a first region), and a second text transcribed message arrives on a second radio channel (e.g., from a second aircraft in a second region), the aircraft supervising system 105 can delay or queue the second message. Then, the second message can be presented after the first message is finished. For example, transcribed messages 481 and 482 may have been broadcast at the same time or partially overlapping time periods, but transcribed message 481 may be displayed in its entirety before transcribed message 482 is displayed. Each of the messages can include an audio message and/or a text transcription of the audio message. As described in more detail below with respect to FIG. 5, audio messages can also delayed for iterative presentation.

The map portion 490 (also referred to as a second window) can include a visual representation of a geographic area with aircraft icons 497 and 498 representing the real time positions of one or more aircraft. Icons may be included for each of the supervisor's aircraft and/or for all known aircraft present in the region (e.g., including aircraft not under the supervisor's supervision).

The map portion 490 can also include supplemental presentation of one of the audio messages included in the text transcription portion 480 of the graphical user interface 471. For example, a message window 491 in the map portion 490 may include information corresponding to the transcribed message 481 in the text transcription portion 480. In some embodiments, the message window 491 may automatically be updated and/or displayed to represent the most recently received one of the messages. In other embodiments, the message window 491 may be displayed in response to a user selection (e.g., click) of the transcribed message 481 (or other desired message) in the text transcription portion 480.

The message window 491 may include message information 492. The message information 492 may include a direct copy, an abbreviation, or some other modified representation of the corresponding transcribed message 481 in the text transcription portion 480.

The message window 491 may include one or more interactive action buttons. These buttons may allow the supervisor to quickly select a response to a message for the aircraft. For example, the message window 491 may include an accept button 493 and a reject button 494. Selection of the accept button 493 may cause the aircraft supervising system to send a response (e.g., an automated voice message) to the air traffic controller indicating that an instruction will be followed, and/or a flight instruction to the aircraft based on message instructions. Selection of the reject button 494 may cause the aircraft supervising system to send a response (e.g., an automated voice message) to the air traffic controller indicating that an instruction will not be followed, and/or a flight instruction to the aircraft to disregard the instruction and/or maintain course.

The message window 491 may include a playback button 495 that, when selected by the supervisor, causes the aircraft supervising system to acoustically play an audio message corresponding to the transcribed message 481. In some embodiments, the audio message may be initially played in real time when first received. Then, the supervisor can select the playback button 495 if the supervisor wishes to listen to the audio message again. In other embodiments, the audio message may not be automatically played, and the supervisor can select the playback button 495 if the supervisor wishes to listen to the audio message for the first time.

In some embodiments, the aircraft supervising system may not acoustically play audio messages for the supervisor, and may instead only display the transcribed text via the graphical user interface 471. In some embodiments, one or more of the transcribed messages 481-486 may be received alone by the aircraft supervising system from the aircraft, without an accompanying audio message.

As shown in FIG. 4A, an aircraft icon 497 associated with a currently displayed message window 491 may be identified by an indicator 496. The indicator 496 may include a circle centered around the aircraft icon 497, a color change of the aircraft icon 497, an increase in brightness of the aircraft icon 497 and/or surrounding area, and/or any other suitable indication or emphasis of the aircraft icon 497. Additionally, the message window 491 may be positioned near and/or linked to (e.g., via a line) to the aircraft icon 497 and/or indicator 496.

FIG. 4B illustrates another example graphical user interface 472 that can include an aircraft list portion 440 and/or a map portion 450.

The graphical user interface 472 of FIG. 4B can advantageously present to the supervisor a more simplified set of information that is easier to understand. Instead of cluttering the screen with text, the graphical user interface 472 can present a set of relevant icons that the supervisor can interact with when more information is desired. Additionally, instead of persistent text, messages for supervised aircraft can appear as they arrive and then fade away after a predetermined amount of time. As a result, the supervisor may be able to understand current communications and flight statuses at a glance without having to sift through large amounts of information.

The aircraft list portion 440 can include a set of one or more flight icons 441-443. Each of the flight icons 441-443 may represent a flight associated with the supervisor, ground control station, and/or aircraft supervising system. For example, flight icon 441 may represent a first flight mission under the supervision of the supervisor, flight icon 442 may represent a second flight mission under the supervision of the supervisor, and flight icon 443 may represent a third flight mission under the supervision of the supervisor.

Each of the flight icons 441-443 may display information associated with the flight and/or aircraft. For example, a flight name, a flight plan (e.g., origin and destination), a current radio channel associated with a current region where the aircraft is located, and/or any other suitable information.

According to embodiments, when a new message directed to one of the supervised aircraft is received at the aircraft supervising system, a text transcription of the message can be displayed on the graphical user interface 472. For example, text box 451 may be a pop-up text box that is displayed when the message (e.g., “Wisk123 turn left 360”) is received. The text box 451 may be displayed temporarily for any suitable amount of time (e.g., 1 second, 2 seconds, 5 seconds, 10 seconds, the duration of the playtime of a corresponding audio message, until the message is acted upon or responded to, etc.)

The text box 451 can be visually associated with a corresponding flight icon (e.g., flight icon 443 in the illustrated example) so that the supervisor can easily determine to which aircraft and flight the message is directed. For example, the text box 451 can be presented at a same or similar vertical height or level as the corresponding flight icon 443, and/or the text box 451 may include an arrow or other indicator pointing toward the corresponding flight icon 443. In some embodiments, the flight icon 443 may simultaneously be emphasized (e.g., highlighted, brightened, outlined, bolded, changed color, etc.) so that is stands out from among the other flight icons.

As shown in FIG. 4B, the text box 451 may be superimposed over the map portion 450. Embodiments allow the text box 451 to alternatively be displayed in any other suitable area, such as above, underneath, or to the left of the aircraft list portion 440, between flight icons 441-443, etc.

According to embodiments, the flight icons 441-443 may be selectable by the supervisor in order to display one or more messages (e.g., the most recent message) directed to that aircraft. For example, if the supervisor selects the flight icon 443, the graphical user interface 472 may be updated to display the text box 451. In this manner, the text box 451 may be displayed for the first time, or redisplayed after having already been displayed previously.

Embodiments allows text boxes with messages directed to other aircraft not under the supervisor's supervision to be presented in other areas of the graphical user interface 472, or to be not presented in order to simplify the display.

In some embodiments, a supervisor's selection (e.g., click) of the flight icon 443 and/or text box 451 may cause an audio message to be played for the supervisor (e.g., a recording of a most recent audio message). In some embodiments, selection of a flight icon may cause a real time live audio feed of a corresponding radio channel to be played for the supervisor.

The map portion 450 can include a visual representation of a geographic area with icons 457 and 458 representing the positions of one or more aircraft. Icons may be included for each of the supervisor's aircraft and/or for all known aircraft present in the region (e.g., including aircraft not under the supervisor's supervision).

According to embodiments, the map portion 450 may be configured to switch between different geographic areas to facilitate surveillance of different aircraft positioned in different geographic areas. In some embodiments, the map portion 450 may switch to displaying a new geographic area in response to receiving a message associated with a supervised aircraft in that region. For example, the currently displayed geographic area shown in FIG. 4B may correspond to the aircraft associated with the flight icon 443 and the text box 451, while the aircraft associated with the flight icons 442 and/or 441 may be located in other geographic areas. In some embodiments, the map portion 450 may periodically (e.g., every 5 seconds, 10 seconds, 30 seconds, etc.) and/or iteratively rotate between a set of predefined geographic areas.

While FIGS. 4A-4B provide examples of user interfaces, other formats and configurations of user interfaces are possible for providing visual interpretations of audio messages and/or other flight information. According to embodiments, the various elements and portions of FIGS. 4A and 4B can be combined or interchanged in any suitable manner. For example, embodiments allow both of the text transcription portion 480 of FIG. 4A and the aircraft list portion 440 of FIG. 4B to be included in the same graphical user interface.

Time-Shift Overlapping Messages from Different Channels

According to embodiments, one or more audio messages can be automatically delayed, buffered, suspended, staggered, or otherwise time-shifted to prevent audio overlap. Air traffic control audio messages can be iteratively queued for a supervisor based on an order of receipt or any suitable determination of priority. This can improve a human supervisor's comprehension of the audio messages. Audio delay and spacing techniques can be described with respect to FIGS. 5-7.

FIG. 5 illustrates an example of multiple audio messages that overlap in time. Each of the audio messages may be received at an aircraft supervising system (e.g., as discussed above with respect to step S9 of FIG. 3). For example, the aircraft supervising system may receive, from one or more aircraft, relays of audio messages being broadcast by air traffic control systems.

According to embodiments, the audio messages may be received from different aircraft located in different geographical regions associated with different radio channels. For example, a first audio message 501 may be received by the aircraft supervising system from a first aircraft in a first geographical region associated with a first radio channel. A second audio message 502 may be received by the aircraft supervising system from a second aircraft in a second geographical region associated with a second radio channel. A third audio message 503 may be received by the aircraft supervising system from a third aircraft in a third geographical region associated with a third radio channel.

Typically, for a single radio channel, audio messages may be spoken one at a time such that overlapping messages may be uncommon. However, an aircraft supervising system that simultaneously monitors multiple radio channels (e.g., as forwarded by respective aircraft) may receive messages from each radio channel at random times or otherwise in an unorganized manner. According to embodiments, each aircraft may filter radio traffic as discussed above with respect to FIG. 3 so that only audio messages targeted for predefined aircraft are forwarded to the aircraft supervising system. Accordingly, for a plurality of aircraft currently located in three different regions with three corresponding radio channels, the aircraft supervising system may receive a filtered subset of audio messages on the radio channels, where the subset of audio messages are directed to a predefined subset of aircraft (e.g., the three aircraft mentioned above). Nonetheless, the filtered audio messages may still overlap in time.

Accordingly, if the aircraft supervising system plays all of the audio messages to the supervisor 106 in real time upon receipt, two or more audio messages may be presented at partially or completely overlapping times. Overlapping audio messages may include overlapping voices that are difficult for a supervisor 106 to disambiguate, thereby causing potential confusion and comprehension issues, as well as in increased likelihood in failing to (or incorrectly) respond to or otherwise act upon an audio message.

As shown in FIG. 5, the first audio message 501 may be received first. The second audio message 502 may initiate while first audio message 501 is still ongoing and has not yet completed. The third audio message 503 may begin while the second audio message 302 is ongoing and has not yet completed.

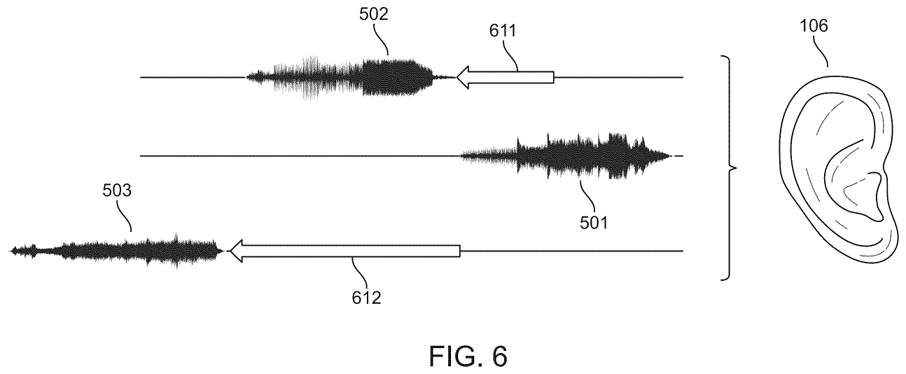

FIG. 6 illustrates an example of time-shifted audio messages. The aircraft supervising system (e.g., via a ground control station) can record, pause, and/or delay each subsequent audio message to prevent overlap. As shown in FIG. 6, the first audio message 501 can be output (e.g., acoustically provided) to the supervisor 106 without delay (e.g. in real time).

When a signal for the first audio message 501 is detected and/or being provided to the supervisor, any other signals can be delayed until the first signal is no longer present. Accordingly, the second audio message 502 can be delayed until the first audio message 501 has been presented to the supervisor 106 completely. The second audio message 502 may be delayed by a first time delay 611 of any suitable length. For example, the second audio message 502 may have a first time delay 611 that causes the second audio message 502 to be acoustically output (e.g., acoustically provided) to the supervisor 106 immediately after the first audio message 501 is complete, or a predetermined amount of time (e.g., ½ second, 1 second, 2 seconds, 3 seconds, 4 seconds, 5 seconds, or any suitable amount of time) has elapsed since completion of the first audio message 501.

According to embodiments, the aircraft supervising system may digitally record the second audio message 502. Then, after the first time delay 611, the aircraft supervising system can playback the digital recording of the second audio message 502.

Similarly, the third audio message 503 can be delayed until the second audio message 502 (which itself was delayed) has been presented to the supervisor 106. The third audio message 503 may be delayed by a second time delay 612 of any suitable amount.

According to embodiments, the aircraft supervising system may provide an audio alert or any other suitable type of alert signal, indicator, or differentiating feature in response to receiving an audio message and/or before acoustically providing an audio message to the supervisor 106. In some embodiments, different audio alerts can be associated with different radio channels and/or different aircraft, thereby helping the supervisor quickly recognize to which aircraft an incoming audio message is directed and/or differentiate radio channels. For example, a first audio alert (e.g., a first chime pattern or tone quality) can be provided to the supervisor 106 before the first audio message 501 to indicate the first aircraft (e.g., as identified by an aircraft identifier or by the message being received via a first direct communication link with the first aircraft) or first radio channel, an acoustically distinct second audio alert (e.g., a second chime pattern or tone quality) can be provided to the supervisor 106 before the second audio message 502 to indicate the second aircraft or second radio channel, and/or an acoustically distinct third audio alert (e.g., a third chime pattern or tone quality) can be provided to the supervisor 106 before the third audio message 503 to indicate the third aircraft or third radio channel. In some embodiments, a corresponding audio alert can be played after completion of an audio message to indicate that the audio message is has ended.

Audio alerts can be differentiated in any suitable manner, such as audio quality, modulation, directional differentiation (e.g., left, right, center, forward, back) on audio headphones. According to embodiments, the audio messages can additionally or alternatively be modified to have distinct qualities (e.g., different pitch, volume, directional differentiation). As additional examples, audio alerts and/or audio messages for the first aircraft may be played through the left headphone, audio alerts and/or audio messages for the second aircraft may be played through the right headphone, and audio alerts and/or audio messages for the third aircraft may be played through both left and right headphones.

According to embodiments, time-shifting audio messages can be performed in conjunction with or without the filtering and/or text transcriptions as discussed above with respect to FIGS. 3, 4A, and 4B.

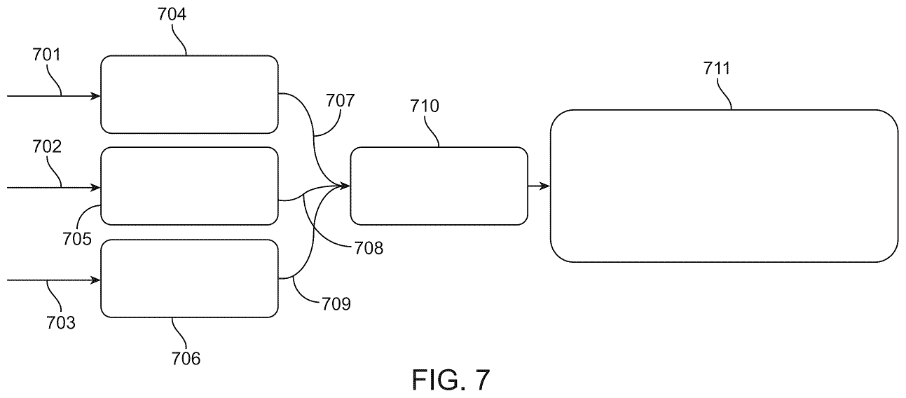

FIG. 7 illustrates a flowchart of a method for providing time-shifting audio messages.

At steps 701, 702, and 703, the aircraft supervising system (e.g., 105 in FIG. 3) can receive (e.g., simultaneous) audio streams from a first aircraft, second aircraft, and third aircraft. Each audio stream may include a non-continuous series of audio messages.

At steps 704, 705, and 706, the aircraft supervising system can parse audio data received from each audio stream into corresponding data packets. Each data packet can comprise an audio message extracted from the audio stream. As discussed above with respect to FIGS. 5-6, the audio messages may overlap in time.

At steps 707, 708, and 709, the aircraft supervising system can forward each of the data packets to a queue for playback to the supervisor. The data packets may be forwarded upon completion of the audio message, or alternatively forwarded in pieces while the audio message is being received and audio data parsed.

At step 710, the aircraft supervising system may assembly a queue of the data packets. The queue may be a first-in-first-out queue that causes audio messages to be provided in the order of when the data packets are added to the queue. In some embodiments, audio messages can be played based on the order of when their transmissions begin. In other embodiments, audio messages can be played based on the order of when their transmissions are completed.

At step 711, the aircraft supervising system can acoustically provide each of the data packets in sequence based on the queue.

As discussed above, embodiments can improve air traffic control communications such that the cognitive burden on a supervisor is reduced and the supervisor's comprehension and performance are improved. This can improve response times, compliance with air traffic control instructions, efficiency, safety, and otherwise improve remote supervision and piloting.

For example, in test scenarios, selective callsign-based audio filtering and audio queuing of overlapping or closely spaced audio transmissions were shown to improve the supervisor's ability to respond correctly.

In a test scenario of a targeted audio message overlapping with two non-targeted audio message, audio filtering and audio queuing improved successful response rates to 100%, as compared to a base level of 80% with no filtering or queuing.

In a test scenario of a targeted audio message overlapping with one non-targeted audio transmission, audio filtering and message queuing improved successful response rates to 100%, as compared to a base level of 73% with no filtering or queuing.

In a test scenario of two targeted audio messages in close sequence with one another, audio filtering and audio queuing improved successful response rates to 93%, as compared to a base level of 60% with no filtering or queuing.

In a test scenario of two targeted audio messages in close sequence while also overlapping with one non-targeted audio transmission, audio filtering and audio queuing improved successful response rates to 93%, as compared to a base level of 7% with no filtering or queuing.

In a test scenario of two targeted audio messages overlapping with one another, audio filtering and audio queuing improved successful response rates to 87%, as compared to a base level of 0% with no filtering or queuing.

### Computer System

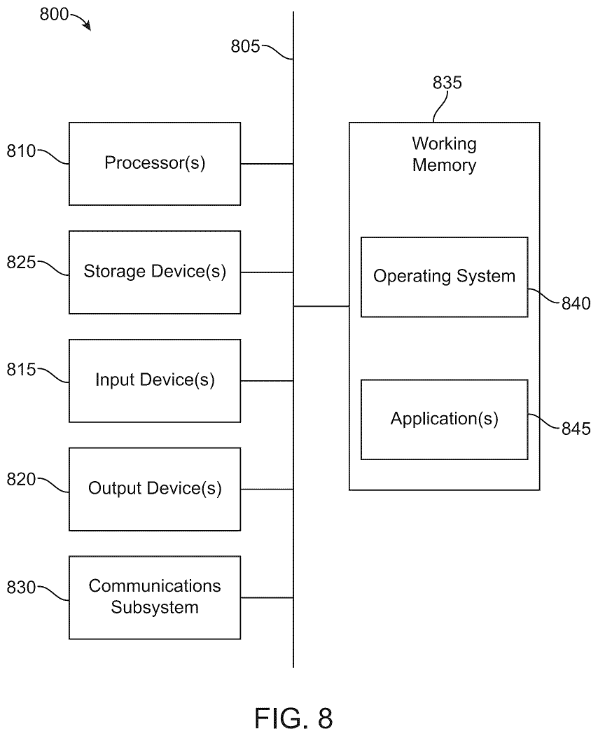

FIG. 8 illustrates aspects of a computer system 800 that may be incorporated as part of the GCS 108, the ATC system 121, the aircraft 115, and/or other components of the voice communications system 100 described above with respect to FIG. 1 and as well as components described with respect to other figures, in accordance with embodiments of this disclosure. FIG. 8 provides a schematic illustration of one embodiment of a computer system 800 that can perform various steps of the methods provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips, graphics acceleration processors, video decoders, and/or the like); one or more input devices 815, which can include without limitation a mouse, a keyboard, remote control, a microphone, and/or the like; and one or more output devices 820, which can include without limitation a display device, a printer, audio speakers, an audio headset, and/or the like.

The computer system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device, and/or a chipset (such as a Bluetooth™ device, an 802.11 device, a Wi-Fi device, a WiMAX device, cellular communication device, etc.), and/or the like. The communications subsystem 830 may permit data to be exchanged with a network (such as the network described below, to name one example), other computer systems, and/or any other devices described herein. In many embodiments, the computer system 800 will further comprise a working memory 835, which can include a RAM or ROM device, as described above.

The computer system 800 also can comprise software elements, shown as being currently located within the working memory 835, including an operating system 840, device drivers, executable libraries, and/or other code (e.g., to configure the computer system 800 with the CVLM algorithm), such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code, including instructions and/or code to configure the computer system 800 with the CVLM algorithm, may be stored on a non-transitory computer-readable storage medium, such as the non-transitory storage device(s) 825 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure, and/or adapt a general-purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

As mentioned above, in one aspect, some embodiments may employ a computer system (such as the computer system 800) to perform methods in accordance with various embodiments of the invention. According to a set of embodiments, some or all of the procedures of such methods are performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another computer-readable medium, such as one or more of the non-transitory storage device(s) 825. Merely by way of example, execution of the sequences of instructions contained in the working memory 835 might cause the processor(s) 810 to perform one or more procedures of the methods described herein.

The terms “machine-readable medium,” “computer-readable storage medium,” “computer-readable medium,” and that plural forms thereof as used herein, refer to any medium or media that participate in providing data that causes a machine to operate in a specific fashion. These mediums may be non-transitory. In an embodiment implemented using the computer system 800, various computer-readable media might be involved in providing instructions/code to processor(s) 810 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 825. Volatile media include, without limitation, dynamic memory, such as the working memory 835.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 830 (and/or components thereof) generally will receive signals, and the bus 805 then might carry the signals (and/or the data, instructions, etc. carried by the signals) to the working memory 835, from which the processor(s) 810 retrieves and executes the instructions. The instructions received by the working memory 835 may optionally be stored on a non-transitory storage device 825 either before or after execution by the processor(s) 810.

It should further be understood that the components of computer system 800 can be distributed across a network. For example, some processing may be performed in one location using a first processor while other processing may be performed by another processor remote from the first processor. Other components of computer system 800 may be similarly distributed. As such, computer system 800 may be interpreted as a distributed computing system that performs processing in multiple locations. In some instances, computer system 800 may be interpreted as a single computing device, such as a distinct laptop, desktop computer, or the like, depending on the context.

Embodiments of the invention provide an aircraft communication system comprising communication equipment, a processor, and a computer-readable medium comprising instructions that when executed by the process cause the processor to perform a method comprising receiving a radio-based audio transmission; generating a live text feed based on the radio-based audio transmission; identifying a predefined text string within the live text feed; and in response to identifying the predefined text string, transmitting a live audio feed of the radio-based audio transmission to the aircraft supervising system.

Embodiments of the invention provide an aircraft supervision system comprising a graphical user interface, a processor, and a computer-readable medium comprising instructions that when executed by the process cause the processor to perform a method comprising receiving a live feed including a plurality of text transcriptions corresponding to a plurality of audio messages, wherein each of the plurality of audio messages is an air traffic control message directed to a corresponding one of a plurality of aircraft, wherein the plurality of aircraft includes a first subset of aircraft associated with an aircraft supervising system; identifying a first subset of the plurality of text transcriptions, wherein each of the first subset of the plurality of text transcriptions correspond to one of the plurality of audio messages that is directed to one of the first subset of aircraft; and displaying, in a first window of the graphical user interface, the plurality of text transcriptions, wherein the first subset of the plurality of text transcriptions are emphasized relative to a remainder of the plurality of text transcriptions.

Embodiments of the invention provide an aircraft supervision system comprising an audio interface, a processor, and a computer-readable medium comprising instructions that when executed by the process cause the processor to perform a method comprising receiving, from a first aircraft located in a first geographical region, a first relay of a first audio message being broadcast by first air traffic control system over a first radio channel associated with the first geographical region; causing the audio interface to acoustically output the first audio message in real time; during acoustically outputting the first audio message, receiving, from a second aircraft located in a second geographical region, a second relay of a second audio message being broadcast by second air traffic control system over a second radio channel associated with the second geographical region; and after completing the acoustically outputting the first audio message, causing the audio interface to acoustically output the second audio message.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by an aircraft communication system of an aircraft, a radio-based audio transmission;
generating, by the aircraft communication system, a live text feed based on the radio-based audio transmission;
identifying, by the aircraft communication system, a predefined text string within the live text feed; and
in response to identifying the predefined text string, transmitting, by the aircraft communication system, a live audio feed of the radio-based audio transmission to the aircraft supervising system.

2. The method of claim 1, wherein the predefined text string is an aircraft identifier associated with the aircraft.

3. The method of claim 1, further comprising:
terminating, by the aircraft communication system, transmission of the live audio feed of the radio-based audio transmission to the aircraft supervising system after a predetermined amount of time or in response to identifying of a second instance the predefined text string within the live text feed.

4. The method of claim 1, wherein transmitting the live audio feed of the radio-based audio transmission to the aircraft supervising system is performed only when the radio-based audio transmission includes an audio message directed to the aircraft, wherein the aircraft is a first aircraft located in a first geographical region, the radio-based audio transmission is a first radio-based audio transmission associated with the first geographical region, the aircraft communication system is a first aircraft communication system, the live text feed is a first live text feed, the predefined text string is a first predefined text string, and the live audio feed is a first live audio feed, and further comprising:
receiving, by a second aircraft communication system of a second aircraft located in a second geographical region, a second radio-based audio transmission;
generating, by the second aircraft communication system, a second live text feed based on the second radio-based audio transmission associated with the second geographical region;
identifying, by the second aircraft communication system, a second predefined text string within the second live text feed; and
in response to identifying the second predefined text string, transmitting, by the second aircraft communication system, a second live audio feed of the second radio-based audio transmission to the aircraft supervising system.

5. The method of claim 1, further comprising:
transmitting, by the aircraft communication system, the live text feed to the aircraft supervising system.

6. The method of claim 1, further comprising:
emphasizing or isolating, by the aircraft communication system, within the radio-based audio transmission, a voice associated with the predefined text string.

7. The method of claim 1, wherein the radio-based audio transmission includes spoken words.

8. A method comprising:
receiving a live feed including a plurality of text transcriptions corresponding to a plurality of audio messages, wherein each of the plurality of audio messages is an air traffic control message directed to a corresponding one of a plurality of aircraft, wherein the plurality of aircraft includes a first subset of aircraft associated with an aircraft supervising system;
identifying a first subset of the plurality of text transcriptions, wherein each of the first subset of the plurality of text transcriptions correspond to one of the plurality of audio messages that is directed to one of the first subset of aircraft; and
displaying, in a first window of a graphical user interface, the plurality of text transcriptions, wherein the first subset of the plurality of text transcriptions are emphasized relative to a remainder of the plurality of text transcriptions.

9. The method of claim 8, wherein each of the plurality of text transcriptions are displayed as separate entries in a vertical stack, and further comprising:
in response to receiving a subsequent text transcription arriving via the live feed, automatically updating the graphical user interface to display the subsequent text transcription as a new entry in the vertical stack and by vertically scrolling the vertical stack to include the subsequent text transcription.

10. The method of claim 8, further comprising:
displaying, within a second window of the graphical user interface, a message window including information associated with a most recently received one of the first subset of the plurality of text transcriptions.

11. The method of claim 10, further comprising:
displaying, in the second window of the graphical user interface, a visual representation of a geographic area including an icon representing a real time position of one of the first subset of aircraft associated with the most recently received one of the first subset of the plurality of text transcriptions; and
displaying, in the second window of the graphical user interface, an indicator for the icon in response to the one of the first subset of the plurality of text transcriptions being the most recently received.

12. The method of claim 8, further comprising:
receiving, at the first window, a user selection of one of the plurality of text transcriptions;
in response to the user selection of one of the plurality of text transcriptions, displaying, within a second window of the graphical user interface, a message window including information associated with the one of the plurality of text transcriptions; and
in response to the user selection of one of the plurality of text transcriptions, displaying, in the second window of the graphical user interface, an indicator for an icon associated with the one of the plurality of text transcriptions, where the icon represents a real time position of a corresponding one of the first subset of aircraft.

13. The method of claim 8, wherein the plurality of audio messages are broadcast over a plurality of radio channels each corresponding to one of a plurality of geographical regions.

14. The method of claim 8, further comprising:
causing an audio alert to be provided to a supervisor in response to receiving each of the first subset of the plurality of text transcriptions is received.

15. The method of claim 8, wherein identifying the first subset of the plurality of text transcriptions includes determining that each of the first subset of the plurality of text transcriptions includes one of a plurality of aircraft identifiers associated with the first subset of aircraft.

16. A method comprising:
receiving, by an aircraft supervising system, from a first aircraft located in a first geographical region, a first relay of a first audio message being broadcast by first air traffic control system over a first radio channel associated with the first geographical region;
acoustically outputting, by the aircraft supervising system, the first audio message in real time;
during acoustically outputting the first audio message, receiving, by the aircraft supervising system, from a second aircraft located in a second geographical region, a second relay of a second audio message being broadcast by second air traffic control system over a second radio channel associated with the second geographical region; and
after completing the acoustically outputting the first audio message, acoustically outputting, by the aircraft supervising system, the second audio message.

17. The method of claim 16, wherein the second audio message is acoustically output after a predetermined amount of time has elapsed since completion of acoustically outputting the first audio message.

18. The method of claim 17, further comprising adding, by the aircraft supervising system, the second audio message to a queue, wherein the acoustically outputting the second audio message is performed in response to the second audio message being next in the queue.

19. The method of claim 16, further comprising:
before acoustically outputting the first audio message, providing a first audio alert; and
after completing the acoustically outputting the first audio message and before acoustically outputting the second audio message, providing a second audio alert, wherein the second audio alert is acoustically distinct from the first audio alert, the first audio alert is associated with the first aircraft or the first radio channel, and the second audio alert is associated with the second aircraft or the second radio channel.

20. The method of claim 16, further comprising:
digitally recording, by the aircraft supervising system, the second audio message, wherein acoustically outputting the second audio message includes playing the digital recording.
